(19) United States
(12) Patent Application Publication
(10) Pub. No.: US 2025/0038261 A1
(43) Pub. Date: Jan. 30, 2025

(54) RECHARGEABLE LITHIUM BATTERY

(71) Applicant: SAMSUNG SDI CO., LTD., Yongin-si (KR)

(72) Inventors: Youngkyeong SHIN, Yongin-si (KR); Tae Hyon BAE, Yongin-si (KR); Harim LEE, Yongin-si (KR); Sanghyung KIM, Yongin-si (KR); Seunghyeon SON, Yongin-si (KR); Arum YU, Yongin-si (KR); Sanghoon KIM, Yongin-si (KR)

(21) Appl. No.: 18/670,322

(22) Filed: May 21, 2024

(30) Foreign Application Priority Data
Jul. 27, 2023 (KR) 10-2023-0098395

(51) Int. Cl. H01M 10/0567; H01M 4/02; H01M 10/0569

(52) U.S. Cl. CPC H01M 10/0567; H01M 4/02; H01M 10/0569; H01M 2004/021; H01M 2004/027

(57) ABSTRACT

A rechargeable lithium battery includes a positive electrode including a positive electrode active material; a negative electrode including a negative electrode active material; and an electrolyte, wherein an active mass density of the negative electrode is greater than or equal to about 1.7 g/cc, and the electrolyte includes a lithium salt; a non-aqueous organic solvent; an additive represented by Chemical Formula 1:

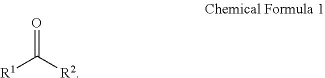

The description of the chemical formula follows the specification.

### CROSS-REFERENCE TO RELATED APPLICATION

The present application claims priority to and the benefit of Korean Patent Application No. 10-2023-0098395, filed on Jul. 27, 2023, in the Korean Intellectual Property Office the entire content of which is incorporated herein by reference.

### BACKGROUND

### 1. Field

The present disclosure herein relates to a rechargeable lithium battery.

### 2. Description of the Related Art

Recently, with the rapid spread (and/or development) of electronic devices that utilize batteries, such as mobile phones, laptop computers, and/or electric vehicles, the demand for rechargeable batteries with relatively high energy density and relatively high capacity is rapidly increasing. Accordingly, research and development to improve the performance of rechargeable lithium batteries are being actively conducted (e.g., underway) or pursued.

A rechargeable lithium battery includes a positive electrode and a negative electrode, each including an active material capable of intercalating and deintercalating lithium ions, and an electrolyte. Electrical energy is produced through oxidation and reduction reactions if (e.g., when) lithium ions are intercalated/deintercalated from the positive electrode and negative electrode.

One of the recent development directions for rechargeable lithium batteries is to increase the density of the negative electrode. However, if (e.g., when) the density of the negative electrode is increased, void volumes decrease, which increases the amount of electrolyte impregnated into the negative electrode, causing an increase in a thickness of the battery and a decrease in cycle-life.

### SUMMARY

Aspects according to some embodiments are directed toward a rechargeable lithium battery that may have an increased density of the negative electrode and effectively suppress the increase in thickness and decrease in cycle-life of the battery.

Additional aspects will be set forth in part in the description which follows and, in part, will be apparent from the description, or may be learned by practice of the presented embodiments of the disclosure.

According to some embodiments, a rechargeable lithium battery includes a positive electrode including a positive electrode active material; a negative electrode including a negative electrode active material; and an electrolyte, wherein an active mass density of the negative electrode is greater than or equal to about 1.7 g/cc, and the electrolyte includes a lithium salt; a non-aqueous organic solvent; and an additive represented by Chemical Formula 1:

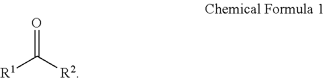

The rechargeable lithium battery according to some embodiments can have an increased density of the negative electrode while suppressing or reducing an increase in battery thickness and a decrease in cycle-life.

### BRIEF DESCRIPTION OF THE DRAWINGS

The accompanying drawings are included to provide a further understanding of the present disclosure and are incorporated in and constitute a part of this specification. The drawings illustrate embodiments of the present disclosure and, together with the description, serve to explain principles of the present disclosure. In the drawings:

FIG. 1 is a schematic illustration of a cylindrical battery according to some embodiments.

FIG. 2 is a schematic illustration of a prismatic battery according to some embodiments.

FIG. 3 is a schematic illustration of a pouch-type or kind battery according to some embodiments.

FIG. 4 is a schematic illustration of a pouch-type or kind battery according to some embodiments.

### DETAILED DESCRIPTION

Hereinafter, embodiments of the present disclosure will be described in more detail. However, these embodiments are examples, the present disclosure is not limited thereto and the scope of the present disclosure is defined by the claims and equivalents thereof.

As used herein, if (e.g., when) specific definition is not otherwise provided, it will be understood that if (e.g., when) an element such as a layer, film, region, or substrate is referred to as being “on” another element, it can be directly on the other element or intervening elements may also be present.

As used herein, if (e.g., when) specific definition is not otherwise provided, the singular expression may also include the plural expression. In addition, unless otherwise specified, “A or B” may refer to “including A, including B, or including A and B.”

As used herein, “a combination thereof” may refer to a mixture, a stack, a composite, a copolymer, an alloy, a blend, and/or a reaction product of the constituents.

As used herein, the “active mass density of the negative electrode” refers to a value calculated by dividing a weight of the components (active material, conductive material, binder, and/or the like) excluding the current collector in the negative electrode by a volume thereof.

As used herein, if (e.g., when) a definition is not otherwise provided, in chemical formulae, hydrogen is bonded at the position if (e.g., when) a chemical bond is not drawn where it is supposed to be given.

As used herein, “fluoroalkyl group” refers to an alkyl group in which one or more or all of the hydrogen atoms are replaced by fluorine atoms.

As used herein, “perfluoroalkyl group” refers to an alkyl group in which all hydrogen atoms are replaced by fluorine atoms.

### Rechargeable Lithium Battery

According to some embodiments, a rechargeable lithium battery including a positive electrode including a positive electrode active material; a negative electrode including a negative electrode active material; and an electrolyte, wherein an active mass density of the negative electrode is greater than or equal to about 1.7 g/cc, and the electrolyte includes a lithium salt; a non-aqueous organic solvent; and an additive represented by Chemical Formula 1:

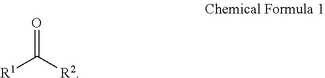

The additive may function as a surfactant having both (e.g., simultaneously) hydrophilic and hydrophobic groups in one molecule.

The additive includes a ketone group at the center and fluorine atoms and/or fluoroalkyl groups of 1 to 10 carbon atoms on both sides (e.g., opposite sides) of the ketone group. Herein, the ketone group is a hydrophilic group, and the fluorine atom or fluoroalkyl group having 1 to 10 carbon atoms is a hydrophobic group.

Accordingly, if (e.g., when) an electrolyte including the additive is utilized, wettability of the positive electrode and negative electrode may be improved, lithium cation (Li⁺) may be uniformly (substantially uniformly) formed at the interface between the positive electrode and the electrolyte, and a stable SEI film may be formed at the interface between the negative electrode and the electrolyte, suppressing or reducing the precipitation of lithium dendrites.

Therefore, if (e.g., when) an electrolyte including additive is utilized, while the active mass density of the negative electrode may be increased to 1.7 g/cc or more, the increase in battery thickness and decrease in cycle-life may be suppressed or reduced.

Hereinafter, a rechargeable lithium battery according to some embodiments will be described in more detail.

### Active Mass Density of Negative Electrode

Comparable rechargeable lithium batteries utilize a negative electrode with an active mass density of less than about 1.7 g/cc, but a rechargeable lithium battery according to some embodiments utilizes a negative electrode with a mixture density of greater than or equal to (e.g., at least) about 1.7 g/cc.

The upper limit for the active mass density of the negative electrode is not particularly limited, but may be less than or equal to about 2.0 g/cc, less than or equal to about 1.9 g/cc, or less than or equal to about 1.8 g/cc.

### Upper Charge Limit Voltage

In the rechargeable lithium battery according to some embodiments, by utilizing an electrolyte including the additive, an increase in the thickness and a decrease in the cycle-life of the battery can be suppressed or reduced even if (e.g., when) the negative electrode is increased in density (e.g., the density of the negative electrode is increased).

For example, the rechargeable lithium battery may have an upper charge limit voltage of greater than or equal to about 4.4 V.

### Additive

In Chemical Formula 1, R¹ and R² may each independently be a fluorine atom or a C1 to C10 fluoroalkyl group.

In some embodiments, R¹ may be a fluoroalkyl group or a perfluoroalkyl group having 2 carbon atoms.

In some embodiments, R² may be a fluoroalkyl group or a perfluoroalkyl group having 3 carbon atoms.

The additive may be represented by Chemical Formula 1-1:

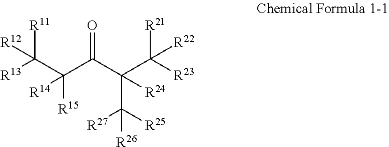

In Chemical Formula 1-1, R¹¹ to R¹⁵ may each independently be a hydrogen atom or a fluorine atom, provided that at least one of (e.g., at least one selected from among) R¹¹ to R¹⁵ is a fluorine atom; and R²¹ to R²⁷ may each independently be a hydrogen atom or a fluorine atom, provided that at least one of (e.g., at least one selected from among) R²¹ to R²⁷ is a fluorine atom.

An example of the additive is represented by Chemical Formula 1-1-1:

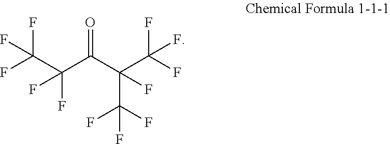 [SMILES: O=C(C(F)(F)C(F)(F)F)C(F)(C(F)(F)F)C(F)(F)F]

### Content of Additive

The additive may be included in an amount of about 0.5 wt % to about 10 wt %, about 0.5 wt % to about 5 wt %, or about 0.5 wt % to about 2 wt % based on a total amount of the electrolyte.

If (e.g., when) the additive is included in an amount greater than (e.g., in excess) of the above ranges, viscosity of the electrolyte including the additive may increase excessively, and wettability of the positive electrode and the negative electrode may actually decrease. On the other hand, if (e.g., when) the content (e.g., amount) of the additive is included in a smaller amount below the above ranges, the effect as a surfactant may be minimal or insufficient.

### Non-Aqueous Organic Solvent

The non-aqueous organic solvent serves as a medium for transmitting (e.g., transporting) ions taking part in the electrochemical reaction of a battery.

The non-aqueous organic solvent may be a carbonate-based, ester-based, ether-based, ketone-based, and/or alcohol-based solvent, an aprotic solvent, and/or a (e.g., any suitable) combination thereof.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and/or the like. The ester-based solvent may include methyl acetate, ethyl acetate, n-propyl acetate, dimethylacetate, methyl propionate, ethyl propionate, propyl propionate, decanolide, mevalonolactone, valerolactone, caprolactone, and/or the like

The ether-based solvent may include dibutyl ether, tetraglyme, diglyme, dimethoxyethane, 2-methyltetrahydrofuran, 2,5-dimethyltetrahydrofuran, tetrahydrofuran, and/or the like. The ketone-based solvent may include cyclohexanone and/or the like. The alcohol-based solvent may include ethyl alcohol, isopropyl alcohol, and/or the like, and the aprotic solvent may include nitriles such as R—CN (wherein R is a C2 to C20 linear, branched, or cyclic hydrocarbon group, a double bond, an aromatic ring, or an ether group), amides such as dimethylformamide, dioxolanes such as 1,3-dioxolane and/or 1,4-dioxolane, sulfolanes, and/or the like.

The non-aqueous organic solvent may be utilized alone or in any combination of two or more.

In the latter case, the non-aqueous organic solvent may include a carbonate-based solvent and a propionate-based solvent.

The total propionate-based solvent may be included in an amount of greater than or equal to about 70 volume % based on a total amount of the non-aqueous organic solvent. In this case, high-voltage and/or high-temperature characteristics of the rechargeable lithium battery may be improved.

For example, the non-aqueous organic solvent may be a mixed solvent of ethylene carbonate (EC), propylene carbonate (PC), and propyl propionate (PP).

### Lithium Salt

The lithium salt dissolved in the organic solvent supplies lithium ions in a battery, enables a basic operation of a rechargeable lithium battery, and improves transportation of the lithium ions between positive and negative electrodes.

In some embodiments, LiPF₆ may be utilized as the lithium salt.

A concentration of the lithium salt may be about 0.1 M to about 2.0 M.

### Positive Electrode Active Material

The positive electrode active material may be a compound (lithiated intercalation compound) capable of intercalating and deintercallating lithium ions. For example, one or more types (kinds) of composite oxides of lithium and a metal selected from among cobalt, manganese, nickel, and combinations thereof may be utilized.

The composite oxide may be a lithium transition metal composite oxide, and specific examples may include lithium nickel-based oxide, lithium cobalt-based oxide, lithium manganese-based oxide, a lithium iron phosphate-based compound, cobalt-free nickel-manganese-based oxide, and/or a (e.g., any suitable) combination thereof.

As an example, a compound represented by any of the following chemical formulas may be utilized. LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}CO_{b}X_{c}O₂₋ₐDₐ (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, O≤b≤0.5, 0≤c≤0.5, 0<α<2); LiₐNi_{b}Co_{c}L¹_{d}GₑO₂ (0.90≤a≤1.8, 0≤b≤0.9, ≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); LiₐFePO₄ (0.90≤a≤1.8).

In the above chemical formulas, A is Ni, Co, Mn, and/or a (e.g., any suitable) combination thereof; X is Al, Ni, Co, Mn, Cr, Fe, Mg, Sr, V, a rare earth element, and/or a (e.g., any suitable) combination thereof; D is O, F, S, P, and/or a (e.g., any suitable) combination thereof; G is Al, Cr, Mn, Fe, Mg, La, Ce, Sr, V, and/or a (e.g., any suitable) combination thereof; and L¹ is Mn, Al, and/or a (e.g., any suitable) combination thereof.

As an example, the positive electrode active material may have a nickel content (e.g., amount) of greater than or equal to about 80 mol %, greater than or equal to about 85 mol %, greater than or equal to about 90 mol %, greater than or equal to about 91 mol %, or greater than or equal to about 94 mol % based on 100 mol % of metals excluding lithium in the lithium transition metal composite oxide, and may be a high nickel-based positive electrode active material with less than or equal to about 99 mol % of nickel. The high-nickel-based positive electrode active materials can achieve high capacity and can be applied to high-capacity, high-density rechargeable lithium batteries.

The positive electrode active material may be, for example, lithium nickel-based oxide represented by Chemical Formula 11, lithium cobalt-based oxide represented by Chemical Formula 12, a lithium iron phosphate-based compound represented by Chemical Formula 13, and cobalt-free lithium nickel manganese-based oxide represented by Chemical Formula 14, and/or a (e.g., any suitable) combination thereof.

Liₐ₁Niₓ₁M¹_{y1}M²_{z1}O_{2-b1}X_{b1} Chemical Formula 11

In Chemical Formula 11, 0.9≤a1≤1.8, 0.3≤x1≤1, 0≤y1≤0.7, 0≤z1≤0.7, 0.9≤x1+y1+z1≤1.1, and 0≤b1≤0.1, M¹ and M² may each independently be one or more elements selected from among Al, B, Ba, Ca, Ce, Co, Cr, Cu, Fe, Mg, Mn, Mo, Nb, Si, Sn, Sr, Ti, V, W, and Zr, and X may be one or more elements selected from among F, P, and S.

In Chemical Formula 11, in an embodiment, 0.6≤x1≤1, 0≤y1≤0.4, and 0≤z1≤0.4, or 0.8≤x1≤1, 0≤y1≤0.2, and 0≤z1≤0.2.

Liₐ₂Coₓ₂M³_{y2}O_{2-b2}X_{b2} Chemical Formula 12

In Chemical Formula 12, 0.9≤a2≤1.8, 0.7≤x2≤1, 0≤y2≤0.3, 0.9≤x2+y2≤1.1, and 0≤b2≤0.1, M³ may be one or more elements selected from among Al, B, Ba, Ca, Ce, Cr, Cu, Fe, Mg, Mn, Mo, Ni, Se, Si, Sn, Sr, Ti, V, W, Y, Zn, and Zr, and X may be one or more elements selected from among F, P, and S.

Liₐ₃Feₓ₃M⁴_{y3}PO_{4-b3}X_{b3} Chemical Formula 13

In Chemical Formula 13, 0.9≤a3≤1.8, 0.6≤x3≤1, 0≤y3≤0.4, and 0≤b3≤0.1, M⁴ may be one or more elements selected from among Al, B, Ba, Ca, Ce, Co, Cr, Cu, Mg, Mn, Mo, Ni, Se, Si, Sn, Sr, Ti, V, W, Y, Zn, and Zr, and X may be one or more elements selected from among F, P, and S.

Liₐ₄Niₓ₄Mn_{y4}M⁵_{z4}O_{2-b4}X_{b4} Chemical Formula 14

In Chemical Formula 14, 0.9≤a4≤1.8, 0.8≤x4<1, 0<y4≤0.2, 0≤z4≤0.2, 0.9≤x4+y4+z4≤1.1, and 0≤b4≤0.1. M⁵ may be one or more elements selected from among Al, B, Ba, Ca, Ce, Cr, Fe, Mg, Mo, Nb, Si, Sn, Sr, Ti, V, W, and Zr, and X may be one or more elements selected from among F, P, and S.

The electrolyte of the above-described embodiments can significantly improve high-voltage and/or high-temperature characteristics of a battery utilizing the lithium cobalt-based oxide represented by Chemical Formula 12.

### Positive Electrode

The positive electrode for a rechargeable lithium battery may include a current collector and a positive electrode active material layer on the current collector. The positive electrode active material layer may include a positive electrode active material and may further include a binder and/or a conductive material.

For example, the positive electrode may further include an additive that can function as a sacrificial positive electrode.

A content (e.g., amount) of the positive electrode active material may be about 90 wt % to about 99.5 wt %, and a content (e.g., amount) of the binder and the conductive material may each independently be about 0.5 wt % to about 5 wt %, based on 100 wt % of the positive electrode active material layer.

The binder serves to attach the positive electrode active material particles suitably (e.g., well) to each other and also to attach the positive electrode active material suitably (e.g., well) to the current collector. Non-limiting examples of the binder may include polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and/or the like.

The conductive material may be utilized to impart conductivity (e.g., electrical conductivity) to the electrode. Any material that does not cause chemical change (e.g., does not cause an undesirable chemical change in the rechargeable lithium battery) and conducts electrons can be utilized in the battery. Examples of the conductive material may include a carbon-based material such as natural graphite, artificial graphite, carbon black, acetylene black, ketjen black, a carbon fiber, a carbon nanofiber, and/or carbon nanotube; a metal-based material containing copper, nickel, aluminum, silver, and/or the like, in a form of a metal powder or a metal fiber; a conductive polymer such as a polyphenylene derivative; or a mixture thereof.

In some embodiments, Al may be utilized as the current collector, but the present disclosure is not limited thereto.

### Negative Electrode Active Material

The negative electrode active material may be a material that reversibly intercalates/deintercalates lithium ions, a lithium metal, a lithium metal alloy, a material capable of doping and dedoping lithium, and/or a transition metal oxide.

The material that reversibly intercalates/deintercalates lithium ions may include a carbon-based negative electrode active material, for example, crystalline carbon, amorphous carbon, and/or a (e.g., any suitable) combination thereof. The crystalline carbon may be graphite such as non-shaped (e.g., irregularly-shaped), sheet-shaped, flake-shaped, sphere-shaped, or fiber-shaped natural graphite or artificial graphite. The amorphous carbon may be a soft carbon, a hard carbon, a mesophase pitch carbonization product, calcined coke, and/or the like.

The lithium metal alloy may include lithium and a metal selected from among Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material or a Sn-based negative electrode active material. The Si-based negative electrode active material may include silicon, a silicon-carbon composite, SiOₓ (0<x≤2), a Si-Q alloy (where Q is selected from among an alkali metal, an alkaline-earth metal, a Group 13 element, a Group 14 element (excluding Si), a Group 15 element, a Group 16 element, a transition metal, a rare earth element, and/or a (e.g., any suitable) combination thereof). The Sn-based negative electrode active material may include Sn, SnOₓ (0<x≤2) (e.g., SnO₂), a Sn-based alloy, and/or a (e.g., any suitable) combination thereof.

The silicon-carbon composite may be a composite of silicon and amorphous carbon. According to some embodiments, the silicon-carbon composite may be in a form of silicon particles and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may be dispersed in an amorphous carbon matrix.

The silicon-carbon composite may further include crystalline carbon. For example, the silicon-carbon composite may include a core including crystalline carbon and silicon particles and an amorphous carbon coating layer on a surface of the core.

The Si-based negative electrode active material or the Sn-based negative electrode active material may be utilized in combination with a carbon-based negative electrode active material.

### Negative Electrode

A negative electrode for a rechargeable lithium battery includes a current collector and a negative electrode active material layer on the current collector. The negative electrode active material layer includes a negative electrode active material and may further include a binder and/or a conductive material.

For example, the negative electrode active material layer may include about 90 wt % to about 99 wt % of the negative electrode active material, about 0.5 wt % to about 5 wt % of the binder, and about 0.5 wt % to about 5 wt % of the conductive material.

The binder may serve to attach the negative electrode active material particles suitably (e.g., well) to each other and also to attach the negative electrode active material suitably (e.g., well) to the current collector. The binder may include a non-aqueous binder, an aqueous binder, a dry binder, and/or a (e.g., any suitable) combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, and/or a (e.g., any suitable) combination thereof.

The aqueous binder may be selected from among a styrene-butadiene rubber, a (meth)acrylated styrene-butadiene rubber, a (meth)acrylonitrile-butadiene rubber, a (meth)acrylic rubber, a butyl rubber, a fluoro rubber, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, and/or a (e.g., any suitable) combination thereof.

When an aqueous binder is utilized as the negative electrode binder, it may further include a cellulose-based compound capable of imparting viscosity. The cellulose-based compound may include one or more of carboxylmethyl cellulose, hydroxypropylmethyl cellulose, methyl cellulose, or alkali metal salts thereof. The alkali metal may be Na, K, or Li.

The dry binder may be a polymer material capable of being fiberized, and may be, for example, polytetrafluoroethylene, polyvinylidene fluoride, polyvinylidene fluoride-hexafluoropropylene copolymer, polyethylene oxide, and/or a (e.g., any suitable) combination thereof.

The conductive material is included to provide electrode conductivity, and any electrically conductive material may be utilized as a conductive material unless it causes a chemical change (e.g., should not cause an undesirable chemical change in the rechargeable lithium battery). Examples of the conductive material may be a carbon-based material such as natural graphite, artificial graphite, carbon black, acetylene black, ketjen black, a carbon fiber, a carbon nanofiber, a carbon nanotube, and/or the like; a metal-based material such as copper, nickel, aluminum silver, and/or the like in a form of a metal powder or a metal fiber; a conductive polymer such as a polyphenylene derivative; or a mixture thereof.

The negative electrode current collector may include one selected from among a copper foil, a nickel foil, a stainless steel foil, a titanium foil, a nickel foam, a copper foam, a polymer substrate coated with a conductive metal, and/or a (e.g., any suitable) combination thereof, but the present disclosure is not limited thereto.

### Separator

Depending on the type or kind of the rechargeable lithium battery, a separator may be present between the positive electrode and the negative electrode. The separator may include polyethylene, polypropylene, polyvinylidene fluoride, a multilayer film of two or more layers thereof, a mixed multilayer film such as a polyethylene/polypropylene two-layer separator, a polyethylene/polypropylene/polyethylene three-layer separator, or a polypropylene/polyethylene/polypropylene three-layer separator, and/or the like.

The separator may include a porous substrate and a coating layer including an organic material, an inorganic material, and/or a (e.g., any suitable) combination thereof on one or both surfaces (e.g., opposite surfaces) of the porous substrate.

The porous substrate may be a polymer film formed of any one selected from among polyolefin such as polyethylene and/or polypropylene, polyester such as polyethylene terephthalate and/or polybutylene terephthalate, polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, and polytetrafluoroethylene (e.g., TEFLON), or a copolymer or mixture of two or more thereof.

The organic material may include a polyvinylidene fluoride-based polymer or a (meth)acrylic-based polymer.

The inorganic material may include inorganic particles selected from among Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and/or a (e.g., any suitable) combination thereof, but the present disclosure is not limited thereto.

The organic material and the inorganic material may be mixed in one coating layer, or a coating layer including an organic material and a coating layer including an inorganic material may be stacked.

### Rechargeable Lithium Battery

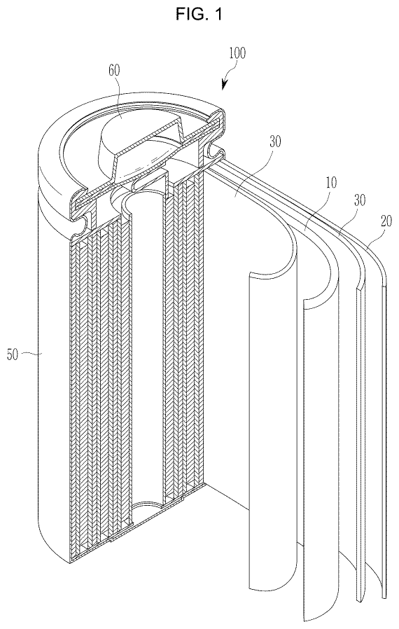

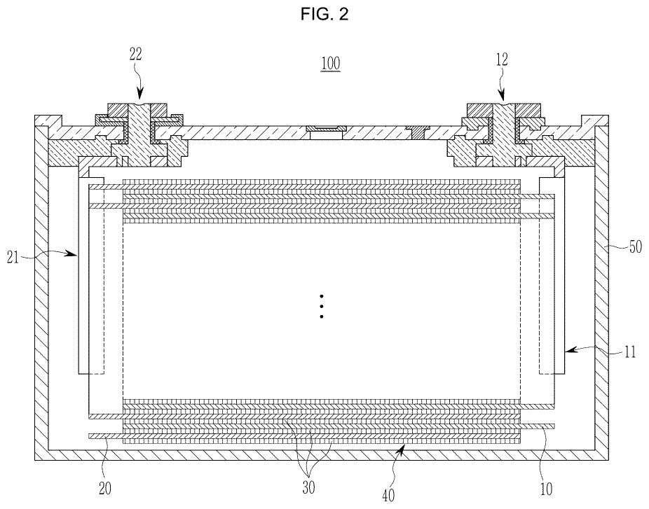

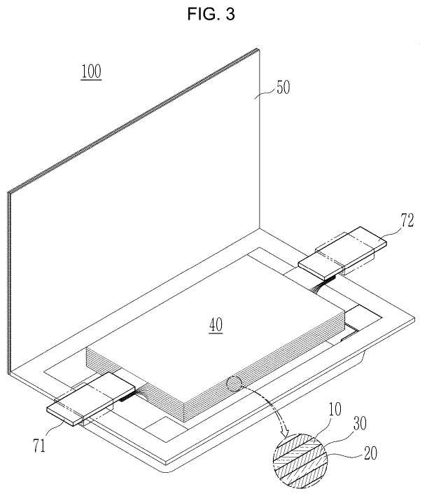

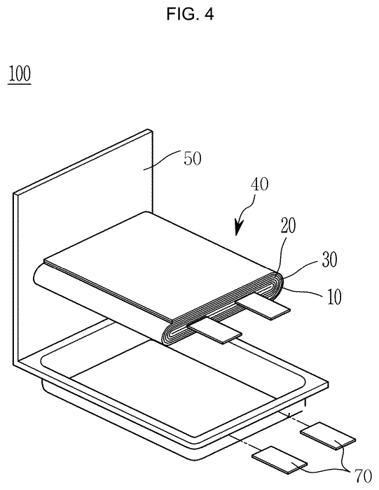

The rechargeable lithium battery may be classified into cylindrical, prismatic, pouch, or coin-type or kind batteries, and/or the like depending on their shape. FIGS. 1 to 4 are schematic views illustrating rechargeable lithium batteries according to one or more embodiments. FIG. 1 shows a cylindrical battery, FIG. 2 shows a prismatic battery, and FIGS. 3 and 4 show pouch-type or kind batteries. Referring to FIGS. 1 to 4, the rechargeable lithium battery 100 may include an electrode assembly 40 including a separator 30 between a positive electrode 10 and a negative electrode 20, and a case 50 in which the electrode assembly 40 is included. The positive electrode 10, the negative electrode 20, and the separator 30 may be impregnated with an electrolyte. The rechargeable lithium battery 100 may include a sealing member 60 sealing the case 50, as shown in FIG. 1. In FIG. 2, the rechargeable lithium battery 100 may include a positive lead tab 11, a positive terminal 12, a negative lead tab 21, and a negative terminal 22. As shown in FIGS. 3 and 4, the rechargeable lithium battery 100 may include an electrode tab 70, which may be, for example, a positive electrode tab 71 and a negative electrode tab 72 serving as an electrical path for inducing (e.g., conducting) the current formed in the electrode assembly 40 to the outside.

The rechargeable lithium battery according to some embodiments may be applied to one or more automobiles, mobile phones, and/or one or more suitable types (kinds) of electrical devices, but the present disclosure is not limited thereto.

Hereinafter, examples of the present disclosure and comparative examples are described. These examples, however, are not in any sense to be interpreted as limiting the scope of the present disclosure.

### Examples and Comparative Examples

Electrolytes and rechargeable lithium battery cells were prepared as follows.

### Example 1

### (1) Preparation of Electrolyte

1.3 M LiPF₆ was dissolved in a non-aqueous organic solvent in which ethylene carbonate (EC), propylene carbonate (PC), and propyl propionate (PP) were mixed in a volume ratio of 10:15:75, and 0.5 wt % of the additive was added thereto to prepare an electrolyte.

The additive represented by Chemical Formula 1-1-1 was utilized:

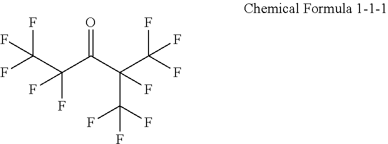 [SMILES: O=C(C(F)(F)C(F)(F)F)C(F)(C(F)(F)F)C(F)(F)F]

Perfluoro(2-methyl-3-pentanone) (CAS No.: 756-13-8)

### (2) Manufacture of Rechargeable Lithium Battery Cells

LiCoO₂ as a positive electrode active material, polyvinylidene fluoride as a binder, and acetylene black as a conductive material were mixed respectively in a weight ratio of 96:3:1, and then, dispersed in N-methyl pyrrolidone to prepare a positive electrode active material slurry.

The positive electrode active material slurry was coated on a 15 μm-thick Al foil, dried at 100° C., and pressed to manufacture a positive electrode.

Artificial graphite as a negative electrode active material, a styrene-butadiene rubber binder, and carboxylmethyl cellulose in a weight ratio of 98:1:1 were dispersed in distilled water to prepare a negative electrode active material slurry.

The negative electrode active material slurry was coated on a 10 μm-thick Cu foil, dried at 100° C., and pressed to manufacture a negative electrode. An active mass density of the negative electrode was set to 1.7 g/cc.

An electrode assembly was manufactured by assembling the positive electrode, the negative electrode, and a separator made of polyethylene with a thickness of 10 μm, and the electrolyte was injected to thereby manufacture a rechargeable lithium battery cell.

### Example 2

An electrolyte and a rechargeable lithium battery cell were prepared in substantially the same manner as in Example 1, except that 1 wt % of the additive was added when preparing the electrolyte.

### Example 3

An electrolyte and a rechargeable lithium battery cell were prepared in substantially the same manner as in Example 1, except that 1.5 wt % of the additive was added when preparing the electrolyte.

### Example 4

An electrolyte and a rechargeable lithium battery cell were prepared in substantially the same manner as in Example 1, except that 2 wt % of the additive was added when preparing the electrolyte.

### Example 5

An electrolyte and a rechargeable lithium battery cell were prepared in substantially the same manner as in Example 1, except that 1 wt % of the additive was added when preparing the electrolyte and an active mass density was set to 1.75 g/cc when preparing a negative electrode.

### Example 6

An electrolyte and a rechargeable lithium battery cell were prepared in substantially the same manner as in Example 1, except that 1 wt % of the additive was added when preparing the electrolyte and an active mass density was set to 1.8 g/cc when preparing a negative electrode.

### Comparative Example 1

An electrolyte and a rechargeable lithium battery cell were prepared in substantially the same manner as in Example 1, except that no additive was added when preparing the electrolyte and an active mass density was set to 1.65 g/cc when preparing a negative electrode.

### Comparative Example 2

An electrolyte and a rechargeable lithium battery cell were prepared in substantially the same manner as in Example 1, except that no additive was added when preparing the electrolyte and an active mass density was set to 1.67 g/cc when preparing a negative electrode.

### Comparative Example 3

An electrolyte and a rechargeable lithium battery cell were prepared in substantially the same manner as in Example 1, except that no additive was added when preparing the electrolyte and an active mass density was set to 1.7 g/cc when preparing a negative electrode.

### Evaluation Examples

The negative electrode and rechargeable lithium battery cell were evaluated in the following manner.

### Evaluation 1: Impregnating Property of Electrolyte for Negative Electrode

The negative electrode according to Example 1 was manufactured as a specimen with width*length=3 cm*4 cm. 1 g of the electrolyte according to Example 1 was dropped on the specimen and left for 1 minute. Thereafter, an amount of electrolyte immersed in the specimen among 100 wt % of the electrolyte dropped on the specimen was evaluated as a value selected from 0 to 5 according to the following criteria, and the evaluation results are shown in Table 1.

0: When the amount of electrolyte immersed in the specimen is 0 wt % or more and less than 10 wt %

1: When the amount of electrolyte immersed in the specimen is 10 wt % or more and less than 20 wt %

2: When the amount of electrolyte immersed in the specimen is 20 wt % or more and less than 40 wt %

3: When the amount of electrolyte immersed in the specimen is 40 wt % or more and less than 60 wt %

4: When the amount of electrolyte immersed in the specimen is 60 wt % or more and less than 80 wt %

5: When the amount of electrolyte immersed in the specimen is 80 wt % or more and less than 100 wt %

Examples 2 to 6 and Comparative Examples 1 to 3 were evaluated in substantially the same manner, and the evaluation results are shown in Table 1.

TABLE 1

| | Active mass | | Impregnating |
|---|---|---|---|
| | density of | | properties of |
| | negative | Additive content | electrolyte for |
| | electrode | (e.g., amount) in | negative |
| | (g/cc) | electrolyte (wt %) | electrode |
| Comparative | 1.65 | 0 | 3 |
| Example 1 | | | |
| Comparative | 1.67 | 0 | 2 |
| Example 2 | | | |
| Comparative | 1.7 | 0 | 1 |
| Example 3 | | | |
| Example 1 | 1.7 | 0.5 | 5 |
| Example 2 | 1.7 | 1 | 5 |
| Example 3 | 1.7 | 1.5 | 5 |
| Example 4 | 1.7 | 2 | 5 |
| Example 5 | 1.75 | 1 | 4 |
| Example 6 | 1.8 | 1 | 4 |

### Evaluation 2: Evaluation of Room-Temperature Charge and Discharge Cycle Characteristics

The rechargeable lithium battery cells were charged and discharged 400 times under the conditions of 25° C., 2.0 C charge (CC/CV, 4.47 V, 0.025 C Cut-off)/1.0 C discharge (CC, 3 V Cut-off).

The thickness increase rates were calculated according to Equation 1, capacity retention rates were calculated according to Equation 2, and the results are shown in Table 2.

$$Thickness increase rate = \{ ( Full charge thickness after 400 cycles ) - ( Full charge thickness after 1 cycle ) \} / ( Full charge thickness after 1 cycle ) * 100 \qquad Equation 1$$

In Equation 1, “full charge thickness” refers to a thickness of the rechargeable lithium battery cells measured after charging at SOC (state of charge) 100% (when the total charge capacity of the battery is set at 100%, charged to 100% charge capacity) after each cycle.

$$Capacity retention rate = ( discharge capacity after 400 cycles / discharge capacity after 1 cycle ) * 100 \qquad Equation 2$$

TABLE 2

| | | | Room-temperature | |
|---|---|---|---|---|
| | | | charge and discharge | |
| | | | characteristics of | |
| | Active mass | | rechargeable lithium | |
| | density of | | battery cells | |
| | negative | Additive content | Thickness | Capacity |
| | electrode | (e.g., amount) in | increase | retention |
| | (g/cc) | electrolyte (wt %) | rate (%) | rate (%) |
| Comparative | 1.65 | 0 | 10.5 | 82.3 |
| Example 1 | | | | |
| Comparative | 1.67 | 0 | 11.1 | 80.5 |
| Example 2 | | | | |
| Comparative | 1.7 | 0 | 17.3 | 76.2 |
| Example 3 | | | | |
| Example 1 | 1.7 | 0.5 | 3.2 | 89.8 |
| Example 2 | 1.7 | 1 | 6.2 | 88.0 |
| Example 3 | 1.7 | 1.5 | 7.5 | 87.6 |
| Example 4 | 1.7 | 2 | 8.8 | 85.3 |
| Example 5 | 1.75 | 1 | 7.9 | 87.2 |
| Example 6 | 1.8 | 1 | 8.2 | 86.6 |

### SUMMARY

Referring to Tables 1 and 2, when an electrolyte including no additives at all (e.g., Comparative Examples 1 to 3), as the active mass density of a negative electrode was increased from 1.65 g/cc to 1.7 g/cc, impregnation properties of the electrolyte to the negative electrode were decreased, thicknesses of battery cells were increased, and cycle-lives were reduced.

However, when the active mass density of the negative electrode was equally set at 1.7 g/cc, compared to an electrolyte including no additives at all (Comparative Example 3), the electrolytes including the additive (e.g., Examples 1 to 4) exhibited increased impregnation properties of the electrolyte to the negative electrode, decreased thicknesses of battery cells, and increased cycle-lives.

Furthermore, when the electrolyte including the additive, even though active mass density of a negative electrode was increased from 1.7 g/cc to 1.8 g/cc (e.g., Examples 5 and 6), an increase in a battery thickness and a decrease in a cycle-life were both suppressed (i.e., desired battery thickness and cycle-life were achieved).

The use of “may” when describing embodiments of the inventive concept refers to “one or more embodiments of the inventive concept.”

As used herein, the term “about,” and similar terms are used as terms of approximation and not as terms of degree, and are intended to account for the inherent deviations in measured or calculated values that would be recognized by those of ordinary skill in the art. “About” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value.

Also, any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. A battery management system (BMS) device, and/or any other relevant devices or components according to embodiments of the present invention described herein may be implemented utilizing any suitable hardware, firmware (e.g. an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the present disclosure.

While this disclosure has been described in connection with what is presently considered to be practical embodiments, it is to be understood that the present disclosure is not limited to the disclosed embodiments, but, on the contrary, is intended to cover various modifications and equivalent arrangements included within the spirit and scope of the appended claims, and equivalents thereof.

Description of symbols

| | |
|---|---|
| 100: rechargeable lithium battery | 10: positive electrode |
| 11: positive electrode lead tab | 12: positive terminal |
| 20: negative electrode | 21: negative electrode lead tab |
| 22: negative terminal | 30: separator |
| 40: electrode assembly | 50: case |
| 60: sealing member | 70: electrode tab |
| 71: positive electrode tab | 72: negative electrode tab |

What is claimed is:

1. A rechargeable lithium battery, comprising
a positive electrode comprising a positive electrode active material;
a negative electrode comprising a negative electrode active material; and
an electrolyte,
wherein an active mass density of the negative electrode is greater than or equal to about 1.7 g/cc, and
the electrolyte comprises:
a lithium salt;
a non-aqueous organic solvent; and
an additive represented by Chemical Formula 1: 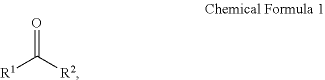
and
wherein, in Chemical Formula 1,
R¹ and R² are each independently a fluorine atom or a C1 to C10 fluoroalkyl group.

2. The rechargeable lithium battery as claimed in claim 1, wherein
the active mass density of the negative electrode is about 1.7 to about 2.0 g/cc.

3. The rechargeable lithium battery as claimed in claim 1, wherein
the additive is represented by Chemical Formula 1-1: 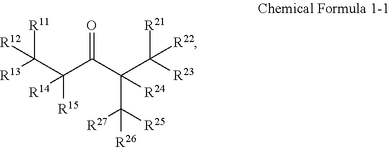
and
wherein, in Chemical Formula 1-1,
R¹¹ to R¹⁵ are each independently a hydrogen atom or a fluorine atom, provided that at least one of R¹¹ to R¹⁵ is a fluorine atom; and
R²¹ to R²⁷ are each independently a hydrogen atom or a fluorine atom, provided that at least one of R²¹ to R²⁷ is a fluorine atom.

4. The rechargeable lithium battery as claimed in claim 1, wherein
the additive is represented by Chemical Formula 1-1-1:

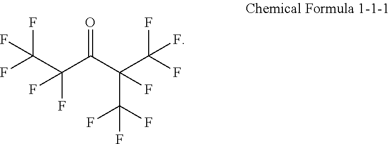 [SMILES: O=C(C(F)(F)C(F)(F)F)C(F)(C(F)(F)F)C(F)(F)F]

5. The rechargeable lithium battery as claimed in claim 1, wherein
the additive is in an amount of about 0.5 wt % to about 10 wt % based on a total amount of the electrolyte.

6. The rechargeable lithium battery as claimed in claim 1, wherein
the non-aqueous organic solvent comprises a carbonate-based solvent and a propionate-based solvent.

7. The rechargeable lithium battery as claimed in claim 1, wherein
the propionate-based solvent is in an amount of greater than or equal to about 70 volume % based on a total amount of the non-aqueous organic solvent.

8. The rechargeable lithium battery as claimed in claim 1, wherein
the lithium salt is LiPF₆.

9. The rechargeable lithium battery as claimed in claim 1, wherein
a concentration of the lithium salt is about 0.1 M to about 2.0 M.

10. The rechargeable lithium battery as claimed in claim 1, wherein
the positive electrode active material comprises lithium nickel-based oxide, lithium cobalt-based oxide, lithium manganese-based oxide, a lithium iron phosphate-based compound, cobalt-free lithium nickel-manganese-based oxide, or a combination thereof.

11. The rechargeable lithium battery as claimed in claim 1, wherein
the negative electrode active material comprises a carbon-based negative electrode active material, a Si-based negative electrode active material, or a combination thereof.

12. The rechargeable lithium battery as claimed in claim 1, wherein
the rechargeable lithium battery has an upper charge limit voltage of greater than or equal to about 4.4 V.
